(19) United States
(12) Patent Application Publication
(10) Pub. No.: US 2020/0337353 A1
(43) Pub. Date: Oct. 29, 2020

(54) MACHINE AND METHOD FOR PREPARING AND DISPENSING FRESH AND HEALTHY FOOD PRODUCE

(71) Applicant: Laith ABDALLAH, JO (SA)

(72) Inventor: Laith ABDALLAH, JO (SA)

(21) Appl. No.: 16/958,766

(22) PCT Filed: Dec. 20, 2018
(86) PCT No.: PCT/SA2018/050031

§ 371 Date: Jun. 29, 2020

(51) Int. Cl. A23N 12/02; A23N 7/02; G07F 17/00; G07F 17/20; G07F 13/10

(52) U.S. Cl. CPC A23N 12/023; A23N 7/026; G07F 13/10; G07F 17/20; G07F 17/0064

(57) ABSTRACT

The present invention relates to an automated machine comprising an apparatus for processing a fresh produce such as apples, pears and the like and then serving it as shown in FIG. 1, that is generally positioned in public places for use by customers and people directly. This machine comprises means for washing, potentially peeling, coring, and cutting into pieces said produce according to the request of a user, and means for cleaning internal components of the processing apparatus. Said automated machine comprises also a processor and a human-machine interface enabling the user to order the produce according to his preferences. The invention also relates to a method for processing a produce and dispensing it to a customer by said machine in order to solve the problem and hassle of consuming apples directly in public places with the lowest cost attainable.

### TECHNICAL FIELD AND BACKGROUND

This invention relates generally to an improved automated machine, and related production process, for producing fresh ready to eat apples and/or pears and the like.

More specifically, the invention relates to an automated machine intended to be placed near the fruit section in minimarkets/grocery stores that allows customers to conveniently get fresh apples and/or pears washed, peeled, sliced, core removed, served, and ready to eat.

During the past years there has been a continuous rising consumer's interest in minimally processed fruits and vegetables for their freshness and convenience. Stimulated largely by consumer demand for fresh, healthy, convenient and additive-free foods, which are safe and nutritious, the market for fresh-cut produces has seen a steep increase. Unfortunately, the rise in consumption of fresh-cut produces increased the frequency of diseases associated with untreated fruits and vegetables.

The high demand of the market encourages researchers to step up efforts to find new processing machines and methods for fresh-cut produces complying with consumer safety regulations governing this area.

Generally, a variety of automatic vending machines for fresh-cut produces, which are operated in response to the input of bills or coins are well known to those skilled in the art.

Both patent literature and non-patent literature from the state of the art disclose several vending machines for sliced and peeled fruits ready to eat. However, the solutions put forward address the problem of providing a healthy fresh produce from a partial perspective. Automatically offering and serving a healthy fresh produce, requires an efficient mechanism to wash the produce instantly as well as cleaning the internal components in contact with said produce.

For example, the European patent EP1469431B1 discloses a vending machine for fresh fruits comprising hygienic protection means, cleaning means for cleaning the processing unit of the vending machine in an automatic way and assuring distribution of the peeled and portioned fruits in excellent hygienic conditions. However, this machine does not offer an instant washing function of the introduced produce, neither the freedom of choosing a specific produce that the customer wants in a supermarket for example, and introducing it into the machine for processing. Other disadvantages of this machine are the high costs incurred in manufacturing it because of its sophisticated many mechanisms, and high costs during its operation. This in effect results in high prices of the dispensed apples, mainly because of the cost of special packaging containers that have to be provided for hygiene, refrigeration costs, and high operation costs of washing, preparing the apples in containers, and refilling them into the machine periodically.

Another example is the vending machine developed by V.M Shoji Co. Ltd. in Japan. Said machine serves packed refrigerated apple slices with choice of peeled or not, after inserting money in it. However, the Japanese vending machine's apples are not fresh and contain preservatives, and the apple slices also cost more because of the sealed packaging, refrigeration, operation and refilling costs.

Another example is the “Feuma apple peeler, corer, and slicer”. Despite its operating efficiency this machine presents many disadvantages. Firstly, it cannot be located commercially in a supermarket for customers to use, as it is intended for industrial use in large kitchens. Moreover, it does not have an instant washing function.

Also available is the Goodell peeler which has a very old design of more than a hundred years, but it doesn't wash or slice the apples, and cannot be easily used by customers in a supermarket.

The French patent FR2692188B1 discloses a machine to peel and chop fruit and vegetables automatically, without using manual instruments, and said machine can remove the fruit core. However, this solution as the above-mentioned solutions does not have an instant washing function.

Despite the progress which has been made toward addressing the problems posed by fresh-cut fruit and vegetables machines, there remains a substantial need for an inexpensive machine comprising an efficient cleaning mechanism of internal components and instant washing and processing of fresh produces, such as apples and/or pears for automatically serving them ready to eat, at the least cost possible to the consumer.

Due to limited options in terms of washed fresh-cut produces easily accessible for purchase at an inexpensive price, customers face an inconvenient hassle every time they go to a minimarket to quickly buy something healthy full of fibers and vitamins to eat on their way to work for example.

The only two main produce options they generally can choose from are:
to purchase an apple then leave the supermarket and go to a place with water supply to wash it from dust, pesticides, and germs; and then arrange for a knife and plate in order to slice it and consume it.
to purchase a fruit salad or packaged produce which is not fresh, mostly contains preservatives, and expensive due to refrigeration costs and packaging/preparation costs.

It is an object of this invention to provide an inventive solution to this technical problem by offering a machine to sell healthy fresh produces washed, peeled and sliced at the wish of the customer, in order to preserve all their taste and health qualities.

A very important novel feature of this machine is its ability to save water during apple's washing to more than 80%. The reason for this is the use of spray nozzles (7) that carefully spray a water mist at high pressure while the apple rotates consuming little amount of water for fully cleaning each apple as opposed to washing the apple under a water tap.

### DESCRIPTION

It is therefore an object of embodiments herein to provide an automated machine, for processing fresh produces, with an integrated instant washing function and cleaning mechanism for internal components.

The present invention addresses the tiresome hassle that customers need to go through when wanting to readily purchase and consume healthy nutritious foods. The invention is a commercial machine intended to be placed near the fruit section in minimarkets/grocery stores that allows customers to conveniently and quickly get fresh apples washed, potentially peeled, sliced, core removed, served, and ready to eat. The customer who wishes to purchase a healthy meal on-the-go would pick up an apple from the fruit section adjacent to the machine or from within the machine itself, insert/place it inside the machine, choose how he would like it to be served (sliced to peeled wedges or wedges with skin), then after several seconds he will receive the washed ready-to-eat apples from the bottom front side of the machine. This will conveniently and easily allow the customer to eat the apple without having to go wash it elsewhere, then get a knife and plate to slice it up.

It is a further object of embodiments herein to unravel problems described above and described below in the detailed description.

In order to overcome the deficiencies of the prior art, the object of the present invention is to provide an automated machine for healthy fresh-cut produces such as apples, pears and the like.

It is well understood for anyone having ordinary skill in the art and by those who practice the invention that the potential peeling device described below, is suitable for peeling large varieties of rounded vegetables and fruit having adequate outermost tissue and tensile strength. Thus, the automated machine disclosed in the present application is not limited to apples and pears, but may extend to other produces.

According to a first aspect of embodiments herein, the object is achieved by an automated machine for processing a produce comprising:

A processor and a human machine interface allowing a user to customize his request;

At least one processing unit comprising a receiving unit for receiving one item of produce. Said receiving unit comprising a housing (14) wherein are arranged the following components:

One base (4) and at least one spike (3) extending vertically from the base (4) to pierce and maintain the produce in a fixed position.

Means for rotating said produce around the axis extending vertically from the base (4).

A washing mechanism for washing said produce before the start of the processing.

Means for peeling an outer surface of said produce in case this feature is provided and the user requests a peeling option.

Means for slicing the produce and removing its core.

A system to lead away and discard the peeled produce skin and the produce core towards a collection pot (13).

Means to serve the sliced produce to the user

Means for dispensing a sanitizing and cleaning solution in addition to a movable spray hose to be easily accessed via a maintenance door

Means for flowing and draining the sanitizing and cleaning solution from the bottom side of the processing unit.

In one embodiment, the apples could be present inside the machine in a compartment so that once the customer makes the required payment, one apple will be presented to him from an opening, where he then takes the apple and places it on the spikes (3), and then closes the access door so that the machine will process the apple. The automated machine of this embodiment can have a payment collection unit suitable for coins and/or bills and/or cards and/or smart devices to collect the payment, or the payment can be made online or via another smart device.

In another embodiment, the automated machine is provided without a payment unit. Hence, the customer can pay for the prepared produce at a checkout counter or any other checkout means related to the jurisdiction where the machine belongs to.

According to a second aspect of the present invention, there is provided a method for dispensing a produce by an automated machine comprising the following steps:

Receiving a customized user request;

Placing the produce in a receiving unit. Said receiving unit is sanitized and cleaned periodically via a maintenance access door

Washing the produce;

Processing the produce;

Dispensing and serving the processed produce.

According to a third aspect of the present invention, there is a processing unit for processing a produce comprising a receiving unit for receiving one item of produce. Said receiving unit comprising a housing (14) wherein are arranged the following components:

One base and at least one spike (3) extending vertically from the base to pierce and maintain the produce in a fixed position.

Means for rotating said produce around the axis extending vertically from the base.

A washing mechanism for washing said produce before the start of the processing.

Means for peeling an outer surface of said produce when the user requests a peeling option.

Means for slicing the produce and removing its core.

A system to lead away and discard the peeled produce skin and the produce core towards a collection pot (13).

Means to serve the sliced produce to the user

Means for dispensing a sanitizing and cleaning solution in addition to a movable spray hose to be easily accessed via a maintenance door

Means for flowing and draining the sanitizing and cleaning solution from the bottom side of the processing unit.

According to a fourth aspect of the present invention, there is provided a method for processing a produce by a processing unit according to a customized user request, said method comprising the following steps:

Placing the produce in a housing (14) disposed in a processing unit. Said processing unit is sanitized and cleaned periodically via a maintenance access door.

Said unit comprising a base and at least one spike (3) extending vertically from the base.

Maintaining the produce in a fixed position by the spike (3).

Washing the produce

Peeling the produce after the washing step in case this feature is provided and the user chooses a peeling option,

Slicing the produce;

Removing the core of the produce.

Dispensing the produce to the user.

Still other aspects, embodiments, and advantages of these exemplary aspects and embodiments are discussed in detail below. Embodiments disclosed herein may be combined with other embodiments in any manner consistent with at least one of the principles disclosed herein.

### BRIEF DESCRIPTION OF THE DRAWINGS

In the various figures, some portions of the machine have been omitted for clarity, such as the structure, or basement of the machine, always with the aim to give a clear and concise description. The annexed drawings do not include structural, common elements, nor any mechanism that may be considered known and/or intuitive for a person skilled in the art.

Preferred and alternative examples of the present invention are described in detail below with reference to the following drawings:

FIG. 1 is a perspective view of the automated machine in its entirety with its principal elements,

FIG. 2 is a perspective view of the processing unit inside the automated machine.

FIG. 3 is a flow chart illustrating the operation of the automated machine according to an embodiment of the present invention.

### DETAILED DESCRIPTION

Aspects and embodiments are directed to an automated machine intended to be placed near the fruit section in minimarkets/grocery stores that allows customers to conveniently get fresh apples washed, peeled, sliced, core removed, served, and ready to eat.

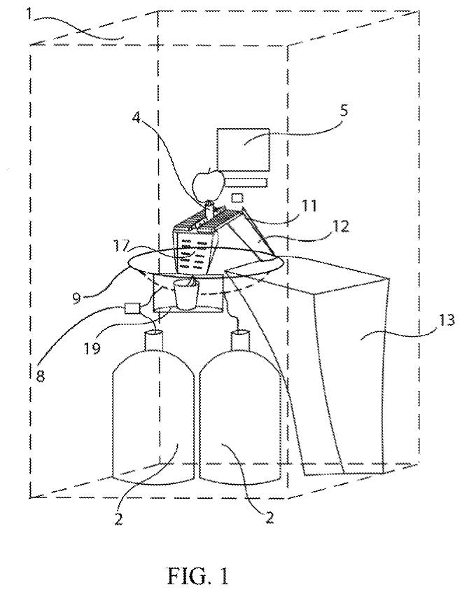

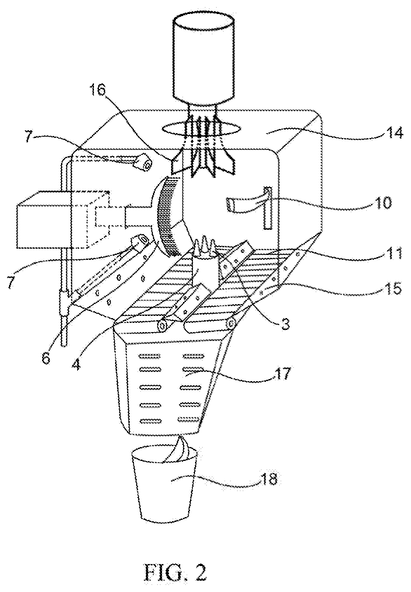

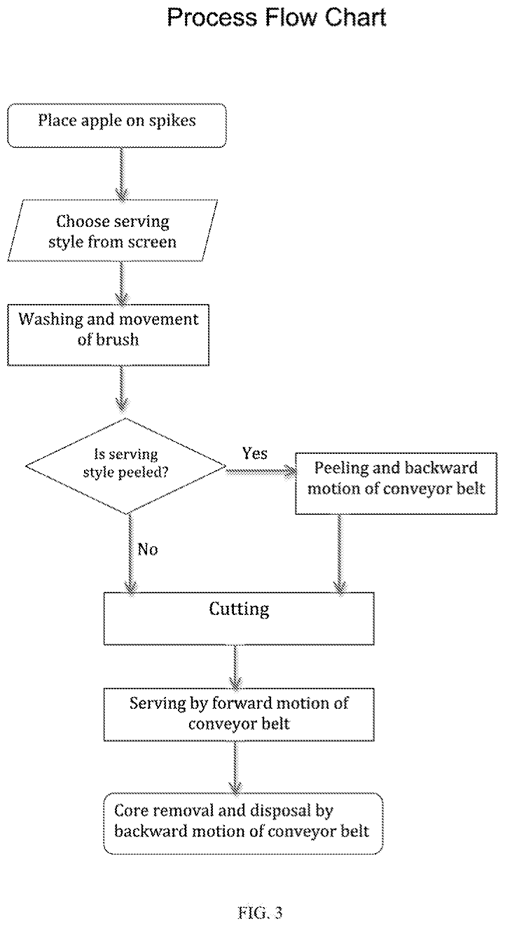

In one embodiment, this invention is composed of a group of mechanisms integrated inside a machine that generally work in turn and sometimes simultaneously as per the selection criteria of the serving style chosen by the customer. This machine can be free standing on the ground. The main body (1) consists of the main part resting on top of two water tanks (2) encased in the main body (1); one for clean washing water and the other for drained water as shown in FIG. 1. Electrical power is supplied to the machine via a main power supply cable and/or batteries. A small opening is located in the front side of the main part of the machine through which the apple is inserted and placed. The customer first places and fixes the apple on top of small spikes (3) protruding from a support (4) close to the opening as shown in FIG. 2. Then he selects his preferred serving style via a control screen/buttons (5). In the following description, the selection that mostly utilizes all the mechanisms will be chosen (apples served as peeled wedges) in which the corresponding processes can be followed as in FIG. 3. However, it is understood by one skilled in the art and those who practice the invention, that the user can choose the type of processing of his produce, thus implying an activation or deactivation of certain functions of the machine.

The washing process is the first process that takes place that puts the first mechanism under operation. At least one brush or sponge (6) is slightly moved forward towards the apple from one side until it is in contact with the apple. Then the bottom support (4) along with the fixed apple start rotating and simultaneously at least one water spray nozzle (7) located adjacent to the brush (6) start spraying clean water towards the rotating apple to clean it from all sides. The water source is supplied from the clean water tank (2) through a small pump (8), and the used water is then drained from beneath the apple in a drain pan (9) and collected towards the drain water tank (2) through tubes by gravity.

It should be noted that proximity, position, or other types of sensors can be used to sense the apple's size and accordingly the cleaning brush, slicing blade, and peeling arm will move towards it.

In one embodiment, there is provided two spraying nozzles (7) for washing the produce.

In another possible embodiment, there is provided two tanks (2) one for washing the produce and cleaning internal components, and the other for drain. This way, It will be easy and convenient for the person in charge to remove and replace the tanks (2) at the end of the day. At the beginning of the day, one tank (2) will be full of water (or water with little cleaning solution), and the other drain tank (2) would be empty. Then as apples are prepared and purchased, a suction pump (8) for similar would draw out water from a hose inserted in the full water tank (2), and the drained water would flow into the other tank (2) by gravity via another hose directed to the drain tank (2).

After that, the peeler mechanism starts operation where the peeler blade arm (10) is moved closer to either the bottom side of the apple or the top and starts peeling as it presses onto the surface of the apple and moves along its profile while the apple rotates so as to peel it. The peeling and rotating can be stopped once the peeler blade arm (10) reaches a limit switch close to the opposite side of the apple. After that, a system located beneath the apple leads away and discards the long peeled apple skin and core outside the machine, or it can be put into operation during the process of peeling simultaneously.

In one embodiment, the system to lead away and discard the peeled apple skin and core is a small conveyer belt located beneath the apple which starts rotating in the backwards direction for a short time in order to discard the long peeled apple skin towards a collection pot (13) located near the back of the machine.

The conveyor belt (11) is located in a housing (14) having an inlet opening corresponding to the opening located in the front side of the main part of the machine through which the apple is inserted and placed, and an outlet opening leading to the collection pot (13) near the back of the machine to discharge the skin and core of the processed produce. Both the conveyor belt (11) and the housing bottom walls (15) have perforation holes allowing the flow of cleaning water and a sanitizing solution.

The cleaning water with cleaning solution can then be drained through the perforation holes after being supplied using a pump (8) from the tank (2) reservoir and drained into drain pan (9).

In a preferred embodiment, the slicing mechanism starts operating by lowering a cutting blade (16) with a central circular hub blade downwards starting from the top of the apple as shown in FIG. 2. This movement continues until the blade reaches below the initial bottom level of the apple and thus the apple wedges fall onto the conveyer belt below. After that, the conveyer belt starts rotating forward towards the front of the machine in order to drop and serve the peeled apple wedges onto a sloping guiding tray (17) that leads towards a disposable cup (18) or dish to be picked by the customer. Then, the cutting blade (16) moves and returns back upwards which causes the core to fall down and drop once its top hits an element incased inside in the center of the cutting blade (16). After that, the conveyor belt (11) starts to rotate backwards so as to move the core and drop it to the backward collection pot (13) along with the peeled apple skin via a sloping backward guide tray (12).

The customer has to place the disposable cup (18), through which apple cut pieces will drop into, on a serving stand (19) at the bottom end of the guiding tray (17).

In another embodiment, the disposable cup (18) can be automatically supplied, positioned, and placed in a similar manner from the inside of the machine.

In one embodiment, the cutting blade (16) with the central circular hub blade could be a star shaped cutting blade with a hole in the center.

In another embodiment, the apple could be supported from its top rather than the bottom in which case the apple is primarily placed in the housing and then spikes move towards it from above to support it and proceed with the processing stages.

In an additional embodiment of the invention, there is provided a function of turning the peeled skin and core into compost. As the peeled skin and core are collected at the bottom back of the machine, they will pass through an automatic food shredder and then will be compressed by a crank-piston mechanism in order to decrease their volume and increase their surface area as preparation for them to be recycled into compost, and thus eliminating waste and protecting the environment. After that, this organic waste ready for composting can be extracted easily in small cubes ready to be taken away to complete the composting cycle.

In another embodiment, the processing unit comprises ultraviolet light sources pointed towards the produce-contact surfaces for the purpose of sanitizing said surfaces by turning on the ultraviolet rays periodically.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

1. An automated machine for processing a produce comprising:
a processor and a human machine interface allowing a user to place and/or customize his order;
at least one processing unit as shown in FIG. 2 comprising a receiving unit for receiving one item of produce in which the user himself inserts or places the produce that he wants. Said receiving unit comprising a housing (14) wherein are arranged the following components:
one base and at least one spike (3) extending vertically from the base to pierce and maintain the produce in a fixed position on it
means for rotating said produce around the axis extending vertically from the base.
a washing mechanism for washing said produce before the start of the processing.
potential provision of means for peeling an outer surface of said produce in case a future customization feature is added to allow the user to request a peeling option.
means for slicing the produce and removing its core.
means to lead away and discard the peeled produce skin and the produce core towards a collection pot (13).
means to serve the sliced produce to the user
means for dispensing a sanitizing and cleaning solution which can be easily accessed via a maintenance door
means for flowing and draining the fluids from the bottom side of the processing unit.

2. The automated machine according to claim 1 further comprising a movable spray hose that can be accessed after opening a maintenance door.

3. The automated machine of claim 1 further comprising ultraviolet light sources pointed towards the produce-contact surfaces and close by surrounding surfaces for the purpose of sterilizing and disinfecting said surfaces.

4. The automated machine of claim 1 further comprising:
at least one tank (2) capable of storing the fluid required for the washing and/or the cleaning process, and a draining tank (2) designed to receive the fluids previously used.

5. The automated machine according to claim 1 wherein the potential peeling is carried out by a blade arm (10) that presses onto the surface of the produce and moves along its profile, for the purpose of fully peeling the produce.

6. The automated machine according to claim 1 wherein the washing mechanism comprises at least one brush or sponge (6) and at least one spray nozzle (7).

7. The automated machine according to claim 1 wherein the means beneath the produce to discard the produce skin and core is a conveyer belt.

8. The automated machine according to claim 1 wherein slicing the produce and removing the core is achieved by a cutting blade (16) with a central circular hub blade.

9. The automated machine according to claim 1 further comprising means for turning the organic peeled skin and core into the compost raw material.

10. A method for selling and dispensing a produce by an automated vending machine comprising the following steps:
receiving a user order or customized request;
placing the produce in a receiving unit by the customer himself. Said receiving unit is sterilized and cleaned periodically via UV radiation sources and via a maintenance access door.
washing the produce;
processing the produce;
dispensing and serving the processed produce.

11. A method for dispensing a produce by an automated machine according to claim 10 wherein the processing step includes provision for peeling an outer surface of the produce when the user chooses a peeling option.

12. A method for dispensing a produce by an automated machine according to claim 10 wherein the processing step includes slicing and removing the core of the produce.

13. A processing unit for processing a produce comprising a receiving unit for receiving the produce. Said receiving unit comprising a housing (14) wherein are arranged the following components:
a base and at least one spike (3) extending vertically from the base to pierce and maintain the produce in a fixed position on it.
means for washing said produce before processing;
a potential provision of a blade arm (10) for peeling an outer surface of said produce;
a cutting blade (16) with a central circular hub blade for slicing the produce and removing the produce core;
means for discarding the peeled produce skin and the produce core towards an external collection pot (13).
means to serve the sliced produce to the user
means for dispensing a sanitizing and cleaning solution which can be easily accessed via a maintenance door
means for flowing and draining the fluids from the bottom side of the processing unit

14. A processing unit for processing a produce according to claim 13 wherein said washing means includes at least one brush (6) and at least one spray nozzle (7).

15. A method for quickly processing a produce by a processing unit according to a user request or order that can be customized, said method comprising the following steps:
placing the produce in a housing (14) disposed in a processing unit. Said processing unit is sterilized and cleaned periodically via ultraviolet radiation sources and via a maintenance access door.
said unit comprising a base and at least one spike (3) extending vertically from the base maintaining the produce in a fixed position on the spike (3).
washing the produce
potential provision of Peeling the produce after the washing step in case the user chooses
a peeling option,
slicing the produce;
removing the core of the produce.
dispensing the produce to the user.

16. A method for processing a produce by a processing unit according to claim 15 wherein the washing step is made by a spraying and/or a brushing mechanism within the processing unit.

17. A method for processing a produce by a processing unit according to claim 15 wherein the peeling is made by a blade arm (10).

18. A method for processing a produce by a processing unit according to claim 15 wherein slicing the produce and removing the core is made by a cutting blade (16) with a central circular hub blade.

19. A technical method for processing a produce by a processing unit according to claim 15 wherein proximity/position sensors are used to sense the apple's size and/or shape, and accordingly the cleaning brush, peeling arm, and/or slicing blade will move towards it in order to clean it, peel it, and/or cut it.
